(19) United States
(12) Patent Application Publication
(10) Pub. No.: US 2008/0020680 A1
(43) Pub. Date: Jan. 24, 2008

(54) Rate-enhanced CMP compositions for dielectric films

(75) Inventors: Robert Vacassy, Aurora, IL (US); Benjamin Bayer, Ashland, VA (US); Zhan Chen, Aurora, IL (US); Jeffrey P. Chamberlain, Aurora, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 11/491,612

(22) Filed: Jul. 24, 2006

(51) Int. Cl. B24B 1/00; B24D 3/02; B24B 7/30; C09K 3/14

(52) U.S. Cl. 451/41; 51/308

(57) ABSTRACT

The invention provides a chemical-mechanical polishing composition consisting essentially of silica, an oxidizing agent, a quaternary ammonium compound, and water. The invention further provides a method of chemically-mechanically polishing a substrate with the aforementioned polishing composition. The polishing composition provides for enhanced polishing rates when used to polish dielectric films.

### FIELD OF THE INVENTION

The invention pertains to chemical-mechanical polishing compositions and methods.

### BACKGROUND OF THE INVENTION

Integrated circuits are made up of millions of active devices formed in or on a substrate, such as a silicon wafer. The active devices are chemically and physically connected into a substrate and are interconnected through the use of multilevel interconnects to form functional circuits. Typical multilevel interconnects comprise a first metal layer, an interlevel dielectric layer, and a second and sometimes subsequent metal layer(s). Interlevel dielectrics, such as doped and undoped silicon dioxide (SiO₂) and/or low-κ dielectrics, are used to electrically isolate the different metal layers. As each layer is formed, typically the layer is planarized to enable subsequent layers to be formed on top of the newly formed layer.

Tungsten is increasingly being used as a conductive material to form the interconnections in integrated circuit devices. One way to fabricate planar tungsten circuit traces on a silicon dioxide substrate is referred to as the damascene process. In accordance with an embodiment of this process, the tungsten damascene process starts with a fully planarized dielectric surface that is patterned with vertical contact holes, or vias, to provide for electrical connection between layers and/or trenches to define circuit lines. An adhesion-promoting layer, typically titanium or titanium nitride, is applied to the substrate surface to adhere the metal to the dielectric surface and to prevent the metal and the dielectric material from reacting. Tungsten is then deposited using a chemical vapor deposition process to fill the holes and/or trenches. Chemical-mechanical polishing (CMP) is employed to reduce the thickness of the tungsten over-layer, as well as the thickness of any adhesion-promoting layer and/or diffusion barrier layer, until a planar surface that exposes elevated portions of the silicon dioxide surface is obtained. The vias and trenches remain filled with electrically conductive tungsten forming the circuit interconnects.

Polishing compositions useful for the CMP of tungsten and other metals often have an acidic pH. Such polishing compositions typically planarize dielectric layers at considerably lower rates than the metals. As the overlying layer of metal is removed, thereby exposing the underlying dielectric surface, metal remaining in the holes and/or trenches continues to be removed while the dielectric surface is more slowly planarized, which results in erosion of metal within the holes and/or trenches and subsequent nonplanarity of the substrate surface. Thus, a need remains in the art for polishing compositions and methods that are effective for polishing both metals and dielectric materials at similar rates in one single polishing step.

### BRIEF SUMMARY OF THE INVENTION

The invention provides a chemical-mechanical polishing composition consisting essentially of (a) silica having an average primary particle size of about 10 nm to about 40 nm, (b) an oxidizing agent selected from the group consisting of hydrogen peroxide, urea hydrogen peroxide, percarbonate salts, benzoyl peroxide, peracetic acid, sodium peroxide, di-tert-butyl peroxide, monopersulfate salts, dipersulfate salts, iron (III) compounds, and combinations thereof, (c) a quaternary ammonium compound comprising a cation with the structure R₁R₂R₃R₄N⁺ wherein R₁, R₂, R₃, and R₄ are independently selected from the group consisting of C₂-C₆ alkyls and C₇-C₁₂ arylalkyls, and (d) water, wherein the polishing composition has a pH of about 1 to about 5.

The invention also provides a method of chemically-mechanically polishing a substrate, which method comprises (i) contacting a substrate with a polishing pad and a chemical-mechanical polishing composition consisting essentially of (a) silica having an average primary particle size of about 10 nm to about 40 nm, (b) an oxidizing agent selected from the group consisting of hydrogen peroxide, urea hydrogen peroxide, percarbonate salts, benzoyl peroxide, peracetic acid, sodium peroxide, di-tert-butyl peroxide, monopersulfate salts, dipersulfate salts, iron (III) compounds, and combinations thereof, (c) a quaternary ammonium compound comprising a cation with the structure R₁R₂R₃R₄N⁺ wherein R₁, R₂, R₃, and R₄ are independently selected from the group consisting of C₂-C₆ alkyls and C₇-C₁₂ arylalkyls, and (d) water, wherein the polishing composition has a pH of about 1 to about 5, (ii) moving the polishing pad relative to the substrate with the chemical-mechanical polishing composition therebetween, and (iii) abrading at least a portion of the substrate to polish the substrate.

### DETAILED DESCRIPTION OF THE INVENTION

The invention provides a chemical-mechanical polishing composition consisting essentially of (a) silica having an average primary particle size of about 10 nm to about 40 nm, (b) an oxidizing agent selected from the group consisting of hydrogen peroxide, urea hydrogen peroxide, percarbonate salts, benzoyl peroxide, peracetic acid, sodium peroxide, di-tert-butyl peroxide, monopersulfate salts, dipersulfate salts, iron (III) compounds, and combinations thereof, (c) a quaternary ammonium compound comprising a cation with the structure R₁R₂R₃R₄N⁺ wherein R₁, R₂, R₃, and R₄ are independently selected from the group consisting of C₂-C₆ alkyls and C₇-C₁₂ arylalkyls, and (d) water, wherein the polishing composition has a pH of about 1 to about 5.

The polishing composition contains silica as an abrasive. The silica can be any suitable form of silica. Useful forms of silica include but are not limited to fumed silica, precipitated silica, and condensation-polymerized silica. Preferably, the silica is a condensation-polymerized silica. Condensation-polymerized silica particles typically are prepared by condensing Si(OH)₄ to form colloidal particles. The precursor Si(OH)₄ can be obtained, for example, by hydrolysis of high purity alkoxysilanes, or by acidification of aqueous silicate solutions. Such abrasive particles can be prepared in accordance with U.S. Pat. No. 5,230,833 or can be obtained as any of various commercially available products, such as the Fuso PL-1, PL-2, and PL-3 products, and the Nalco 1050, 2327, and 2329 products, as well as other similar products available from DuPont, Bayer, Applied Research, Nissan Chemical, and Clariant.

As is well known in the art, abrasive particles comprise, at the lowest level of structure, primary particles. Primary particles are formed by covalent bonds between atoms comprising the particles and are stable to all but the harshest conditions. At the next level of structure, primary particles are associated into secondary particles, generally referred to as aggregates. Aggregate particles comprise primary particles and are bonded together by covalent bonds and electrostatic interactions, and typically are resistant to degradation by, e.g., mechanical energy inputs such as high-shear mixing. At the next level of structure, aggregates are more loosely associated into agglomerates. Typically, agglomerates can be disassociated into the constituent aggregates via mechanical energy inputs. Depending on the particular composition and method of preparation, primary particles and secondary particles (e.g., aggregates) can have shapes ranging from spherical to elliptical, and some aggregates can have extended, chain-like structures. For example, pyrogenic, or fumed, silica typically exists in the form of aggregates having a chain-like structure. Precipitated silicas, for example, silicas prepared by neutralization of sodium silicate, have an aggregate structure in which approximately spherical primary particles are associated into aggregates that resemble a “bunch of grapes.” Both primary abrasive particles and aggregated primary particles (e.g., secondary particles) can be characterized as having an average particle size. In this regard, particle size refers to the diameter of the smallest sphere that encloses the particle. It is to be noted that monodispersed silica particles can be prepared under certain conditions, wherein the monodispersed particles are substantially nonaggregated.

The abrasive typically has an average primary particle size of about 10 nm or more (e.g., about 15 nm or more, or about 20 nm or more). Preferably, the abrasive has an average primary particle size of about 40 nm or less (e.g., about 35 nm or less, or about 30 mm or less). More preferably, the abrasive has an average primary particle size of about 10 nm to about 40 nm, or about 15 nm to about 35 nm.

When the abrasive comprises aggregates of primary particles, the abrasive typically has an average aggregate particle size of about 20 nm or more (e.g., about 30 nm or more, or about 40 nm or more, or about 50 nm or more). Preferably, the abrasive has an average aggregate particle size of about 150 nm or less (e.g., about 100 nm or less, or about 90 nm or less, or about 80 nm or less). More preferably, the abrasive has an average aggregate particle size of about 20 nm to about 150 nm, or about 30 mm to about 100 nm, or about 40 nm to about 90 nm, or about 50 nm to about 80 nm.

The abrasive desirably is suspended in the polishing composition, more specifically in the water of the polishing composition. When the abrasive is suspended in the polishing composition, the abrasive preferably is colloidally stable. The term colloid refers to the suspension of abrasive particles in the water. Colloidal stability refers to the maintenance of that suspension over time. In the context of this invention, an abrasive is considered colloidally stable if, when the abrasive is placed into a 100 ml graduated cylinder and allowed to stand unagitated for a time of 2 hours, the difference between the concentration of particles in the bottom 50 ml of the graduated cylinder ([B] in terms of g/ml) and the concentration of particles in the top 50 ml of the graduated cylinder ([T] in terms of g/ml) divided by the initial concentration of particles in the abrasive composition ([C] in terms of g/ml) is less than or equal to 0.5 (i.e., {[B]−[T]}/[C]≦0.5). The value of [B]−[T]/[C] desirably is less than or equal to 0.3, and preferably is less than or equal to 0.1.

compound serves to reoxidize the iron (II) compound to an iron (III) compound, although it is possible for the per-type oxidizing agent to oxidize the metal directly in addition to its role as re-oxidizer for the iron (III) compound.

The polishing composition contains a quaternary ammonium compound comprising a cation with the structure R₁R₂R₃R₄N⁺, wherein the R₁, R₂, R₃, and R₄ groups of the tetraalkylammonium cation are independently selected from the group consisting of straight-chain, branched, or cyclic C₂-C₆ alkyl or C₇-C₁₂ arylalkyl residues. The quaternary ammonium compound comprises any suitable anion. Examples of suitable anions include hydroxide, chloride, bromide, iodide, nitrate, sulfate, hydrogensulfate, phosphate, hydrogenphosphate, dihydrogenphosphate, and sulfonate (e.g., p-toluenesulfonate). In some embodiments, the polishing composition can comprise two or more quaternary ammonium compounds, which quaternary ammonium compounds are as recited herein.

Examples of suitable tetraalkylammonium cations include tetraethylammonium, tetrapropylammonium, tetrabutylammonium, tetrapentylammonium, tetrahexylammonium, benzyltrimethylammonium, and the like. Preferably, the tetraalkylammonium cation is tetraethylammonium, tetrapropylammonium, or tetrabutylammonium. Specific examples of suitable tetraalkylammonium compounds include but are not limited to tetraethylammonium hydroxide, tetraethylammonium nitrate, tetrapropylammonium hydroxide, tetrapropylammonium nitrate, tetrabutylammonium hydroxide, and tetrabutylammonium nitrate.

It will be appreciated that the specific nature of the tetraalkylammonium compound in the polishing composition will depend on the particular anion associated with the tetraalkylammonium compound that is used to prepare the polishing composition and on the pH of the polishing composition. For example, if a tetraalkylammonium hydroxide is used to formulate the polishing composition and the pH of the polishing composition at the point-of-use (e.g., on the surface of a substrate being polished with the polishing composition) is acidic (i.e., wherein the pH of the polishing composition is less than about 7), the equilibrium concentration of hydroxide will be decreased relative to the initial concentration of hydroxide supplied by the tetraalkylammonium hydroxide, due to rapid acid-base reaction of the hydroxide with the particular acid or acids used to adjust the pH of the polishing composition. Thus, at an acidic pH, the actual tetraalkylammonium compound present in the polishing composition will comprise the conjugate base of the acid used to adjust the pH of the polishing composition. For example, a polishing composition comprising tetraalkylammonium hydroxide in water adjusted with nitric acid to a pH of 3 will comprise tetraalkylammonium nitrate at that particular pH.

The polishing composition can contain any suitable amount of the quaternary compound. Typically, about 10 ppm or more (e.g., about 100 ppm or more) of the quaternary compound will be present in the polishing composition. More typically, about 250 ppm or more (e.g., about 500 ppm or more) of the quaternary compound will be present in the polishing composition. The amount of the quaternary compound typically will not exceed about 5000 ppm (e.g., will not exceed about 2500 ppm). Preferably, the amount of the quaternary compound is about 250 ppm to about 2500 ppm (e.g., about 500 ppm to about 2250 ppm, or about 750 ppm to about 2000 ppm).

The polishing composition desirably has a pH that is about 9 or less (e.g., about 8 or less, or about 6 or less, or about 4 or less). Preferably, the polishing composition has a pH of about 1 or more (e.g, about 2 or more). Even more preferably, the polishing composition has a pH of about 2 to about 5 (e.g., about 2 to about 4). The polishing composition optionally contains pH adjusting agents, for example, nitric acid or potassium hydroxide. The polishing composition optionally contains a pH buffering system, for example, potassium hydrogen phthalate. Many such pH buffering systems are well known in the art.

When the polishing composition contains a combination of an iron (III) compound and a per-type oxidizing agent, the polishing composition optionally comprises a stabilizer. It is well known that hydrogen peroxide and other per-type oxidizing agents are not stable in the presence of many metal ions, including iron (III) compounds, without the use of stabilizers. Without the stabilizer, the metal ion or ions and per-type oxidizing agent may react in a manner that degrades the per-type oxidizing agent over time.

A suitable stabilizer improves the stability of the per-type oxidizing agent but does not materially affect the chemistry of the chemical-mechanical polishing composition in that the presence of the stabilizer does not substantially affect the removal rate exhibited by the polishing composition when used to chemically-mechanically polish a given substrate. Useful stabilizers include but are not limited to phosphoric acid, organic acids (e.g., malonic acid, citric acid, adipic acid, oxalic acid, phthalic acid, and ethylenediaminetetraacetic acid), nitriles, and other ligands that are capable of binding to metal ions and reducing their reactivity towards per compounds. It will be appreciated that the aforementioned acids can exist in the form of a salt (e.g., a metal salt, an ammonium salt, or the like), an acid, or as a partial salt thereof. For example, malonates include malonic acid, as well as mono- and di-salts thereof. Preferred stabilizers are selected from the group consisting of malonic acid, citric acid, adipic acid, oxalic acid, and mixtures thereof. An especially preferred stabilizer is malonic acid.

The stabilizer can be present in the polishing composition in any suitable amount. Desirably, the amount of stabilizer is based on the amount of the iron (III) compound that is present in the composition. Preferably, the amount of stabilizer will be about 1 molar equivalent or more (e.g., about 2 molar equivalents or more) as compared to the amount of the iron (III) compound. The amount of stabilizer will typically be less than about 5 molar equivalents as compared to the amount of the iron (III) compound.

The polishing composition optionally contains a biocide to inhibit bacterial growth in the polishing composition during storage. Non-limiting examples of suitable biocides include the Kathon® biocides from Rohm and Haas, Philadelphia, Pa.

Desirably, the polishing composition does not contain a corrosion inhibitor. In the context of the invention, a corrosion inhibitor is a component that functions to reduce the removal rate and/or the static etch rate of a metal being polished with the inventive polishing composition when added to the polishing composition. Examples of corrosion inhibitors include anionic surfactants, nonionic surfactants, amphoteric surfactants and polymers, and heterocyclic organic compounds. Anionic surfactants include surfactants having functional groups selected from the group consisting of sulfonate, sulfate, carboxylate, phosphate, and derivatives thereof. Nonionic surfactants include silicon-based compounds, fluorine-based compounds, esters, ethylene oxide derivatives, alcohol, ethoxylates, ethers, glycosides, and derivatives thereof. Amphoteric surfactants include polycarboxylates, polyacrylamides, cellulose, polyvinylalcohols, polyvinylpyrrolidones, and derivatives thereof. Examples of heterocyclic organic compounds that function as corrosion inhibitors include azoles such as imidazole and derivatives thereof, and triazoles, such as benzotriazole, tolyltriazole, and the like.

The chemical-mechanical polishing composition can be produced by any suitable technique, many of which are known to those skilled in the art. For example, the silica, oxidizing agent(s) and quaternary ammonium compound(s) may be combined in water before applying the polishing composition to a substrate, or they may be applied separately, e.g., in the form of aqueous dispersions or aqueous solutions, to a polishing pad or to a substrate before or during substrate polishing. Generally, the components of the polishing composition may be prepared by combining the ingredients in any order. The term “component” as used herein includes individual ingredients (e.g., silica, oxidizing agent(s), quaternary ammonium compound(s), etc.) as well as any combination of ingredients.

For example, the oxidizing agent(s) and the quaternary ammonium compound(s) can be combined in water at predetermined concentrations and mixed until such components are completely dissolved. A concentrated dispersion of silica then can be added, and the mixture diluted to give the desired concentration of silica in the final polishing composition. Optionally, a stabilizer, a biocide, and/or a pH adjusting agent can be added to the polishing composition at any time during the preparation of the polishing composition, e.g., before or after addition of the oxidizing agent(s) and the quaternary ammonium compound(s), and before or after adding the silica, and mixed by any method that is capable of incorporating the ingredients into the polishing composition. The mixture can be filtered, if desired, to remove large particulate contaminants such as agglomerated silica or other contaminants before use.

The polishing composition can be prepared prior to use, with one or more components, such as the oxidizing agent(s), added to the polishing composition just before use (e.g., within about 1 minute before use, or within about 5 minutes before use, or within about 1 hour before use, or within about 24 hours before use, or within about 7 days before use). For example, when the polishing composition contains a per-type oxidizing agent and an iron (III) compound, the per-type oxidizing agent may decompose in the presence of the iron (III) compound. In such a situation, the per-type oxidizing agent or the iron (III) compound may be added to the polishing composition immediately before use (e.g., within about 1 minute before use, or within about 5 minutes before use, or within about 1 hour before use, or within about 24 hours before use, or within about 7 days before use).

The chemical-mechanical polishing composition can be supplied as a one package system containing silica, the oxidizing agent(s), the quaternary ammonium compound(s), and water. Optionally, one or more oxidizing agent(s) can be placed in a second or third container. Furthermore, the components in the first or second container can be in dry form while the components in the corresponding container can be in the form of an aqueous dispersion. If the oxidizing agent(s) is a solid, it may be supplied either in dry form or as an aqueous mixture, separately from the other components of the polishing composition. Other two-container, or three- or more container, combinations of the components of the polishing composition are within the knowledge of one of ordinary skill in the art.

The polishing composition also can be provided as a concentrate which is intended to be diluted with an appropriate amount of water prior to use. In such an embodiment, the polishing composition concentrate can contain silica, an oxidizing agents(s), a quaternary ammonium compound(s), and water in amounts such that, upon dilution of the concentrate with an appropriate amount of water, each component of the polishing composition will be present in the polishing composition in an amount within the appropriate range recited above for each component. For example, the silica, an oxidizing agents(s), and quaternary ammonium compound(s) can each be present in the concentrate in an amount that is about 2 times (e.g., about 3 times, about 4 times, or about 5 times) greater than the concentration recited above for each component so that, when the concentrate is diluted with an equal volume of water (e.g., 2 equal volumes water, 3 equal volumes of water, or 4 equal volumes of water, respectively), each component will be present in the polishing composition in an amount within the ranges set forth above for each component. Furthermore, as will be understood by those of ordinary skill in the art, the concentrate can contain an appropriate fraction of the water present in the final polishing composition in order to ensure that the oxidizing agent(s), quaternary ammonium compound(s), and other optional components (e.g., a stabilizer and/or a biocide) are at least partially or fully dissolved in the concentrate. In another embodiment, the polishing composition concentrate can contain silica, quaternary ammonium compound(s), and water in amounts such that, upon dilution of the concentrate with an appropriate amount of a solution of an oxidizing agents(s) in water, each component of the polishing composition will be present in the polishing composition in an amount within the appropriate range recited above for each component.

While the components of the polishing system can be combined well before or even shortly before use, the components of the polishing composition can be combined at or near the point-of-use. As utilized herein, the term “point-of-use” refers to the point at which the polishing composition is contacted with the substrate surface. When the components of the polishing composition are to be combined using point-of-use mixing, the components of the polishing composition are separately stored in two or more storage devices.

In order to mix components of the polishing composition contained in storage devices at or near the point-of-use, the storage devices typically are provided with one or more flow lines leading from each storage device to the point-of-use of the polishing composition (e.g., the platen or the substrate surface). By the term “flow line” is meant a path of flow from an individual storage container to the point-of-use of the component stored therein. The one or more flow lines can each lead directly to the point-of-use, or, in the case that more than one flow line is used, two or more of the flow lines can be combined at any point into a single flow line that leads to the point-of-use. Furthermore, any of the one or more flow lines (e.g., the individual flow lines or a combined flow line) can first lead to one or more of the other devices (e.g., pumping device, measuring device, mixing device, etc.) prior to reaching the point-of-use of the component(s). The flow rate at which the components of the polishing composition are delivered to the surface of the substrate (i.e., the delivered amount of the particular components of the polishing composition) can be altered prior to the polishing process and/or during the polishing process, such that the polishing characteristics, for example, the polishing rate, of the polishing composition are altered.

The components of the polishing composition can be delivered to the point-of-use independently (e.g., the components are delivered to the substrate surface whereupon the components are mixed during the polishing process), or the components can be combined immediately before delivery to the point-of-use. Components are combined “immediately before delivery to the point-of-use” if they are combined less than 10 seconds prior to reaching the point-of-use, preferably less than 5 seconds prior to reaching the point-of-use, more preferably less than 1 second prior to reaching the point of use, or even simultaneous to the delivery of the components at the point-of-use (e.g., the components are combined at a dispenser). Components also are combined “immediately before delivery to the point-of-use” if they are combined within 5 m of the point-of-use, such as within 1 m of the point-of-use or even within 10 cm of the point-of-use (e.g., within 1 cm of the point of use).

When two or more of the components of the polishing composition are combined prior to reaching the point-of-use, the components can be combined in the flow line and delivered to the point-of-use without the use of a mixing device. Alternatively, one or more of the flow lines can lead into a mixing device to facilitate the combination of two or more of the components. Any suitable mixing device can be used. For example, the mixing device can be a nozzle or jet (e.g., a high pressure nozzle or jet) through which two or more of the components flow. Alternatively, the mixing device can be a container-type mixing device comprising one or more inlets by which two or more components of the polishing composition are introduced to the mixer, and at least one outlet through which the mixed components exit the mixer to be delivered to the point-of-use, either directly or via other elements of the apparatus (e.g., via one or more flow lines). Furthermore, the mixing device can comprise more than one chamber, each chamber having at least one inlet and at least one outlet, wherein two or more components are combined in each chamber. If a container-type mixing device is used, the mixing device preferably comprises a mixing mechanism to further facilitate the combination of the components. Mixing mechanisms are generally known in the art and include stirrers, blenders, agitators, paddled baffles, gas sparger systems, vibrators, etc.

The invention further provides a method of chemically-mechanically polishing a substrate comprising (i) contacting a substrate with a polishing pad and the polishing composition described herein, (ii) moving the polishing pad relative to the substrate with the polishing composition therebetween, and (iii) abrading at least a portion of the substrate to polish the substrate.

The method of the invention can be used to polish any suitable substrate, and is especially useful for polishing substrates comprising an insulating layer such as metal oxide, porous metal oxide, and glass (e.g., borophosphosilicate glass). Suitable metal oxides include silicon oxide. When the insulating layer comprises a silicon oxide, the silicon oxide can be derived from any suitable precursor. Preferably, the silicon oxide is derived from silane precursors, more preferably from oxidized silane precursors such as tetraethylorthosilicate (TEOS). The silicon oxide can be prepared using any suitable method, for example, by plasma-enhanced deposition of tetraethylorthosilicate (PETEOS).

The method of the invention can be used to polish any suitable substrate comprising a dielectric layer. In that regard, the inventive method is useful in conjunction with the polishing of an interlayer dielectric (ILD). The inventive method is especially useful for polishing substrates comprising an insulating layer and further comprising a metal selected from the group consisting of tungsten, copper, tantalum, tantalum nitride, aluminum, titanium, titanium nitride, and combinations thereof, and is especially useful for polishing substrates comprising silicon oxide and tungsten. Suitable substrates include wafers used in the semiconductor industry. The polishing composition is particularly well-suited for planarizing or polishing a substrate comprising tungsten and silicon oxide that has undergone so-called damascene processing. Damascene processing typically involves providing a silicon substrate upon which is deposited a layer of silicon oxide and then an adhesion layer (e.g., titanium or titanium nitride). A pattern of trenches and/or vias is defined on the top layer of the substrate by photolithography, and then the patterned regions are etched to provide trenches and/or vias in the substrate surface. The substrate is overcoated with tungsten to fill the trenches and/or vias, and the excess tungsten is removed by chemical-mechanical polishing using a polishing composition so that the tungsten in the trenches and/or vias is substantially level with the silicon oxide resident on the substrate surface. Desirably, the polishing of the substrate to remove the tungsten and expose the silicon oxide is carried out with the polishing composition of the invention, preferably such that the tungsten is substantially removed and the silicon dioxide is adequately planarized without excessive erosion of tungsten on the substrate surface. Advantageously, when the polishing composition comprises a low level of the oxidizing agent, or even substantially no oxidizing agent, the polishing composition can be used to buff the substrate after removal of the excess tungsten, or the polishing composition can be used to chemically-mechanically polish dielectric layers (e.g., substrates comprising interlayer dielectrics).

The polishing method of the invention is particularly suited for use in conjunction with a chemical-mechanical polishing (CMP) apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate to polish the substrate.

A substrate can be polished with the inventive polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

Desirably, the CMP apparatus further comprises an in situ polishing endpoint detection system, many of which are known in the art. Techniques for inspecting and monitoring the polishing process by analyzing light or other radiation reflected from a surface of the workpiece are known in the art. Such methods are described, for example, in U.S. Pat. No. 5,196,353, U.S. Pat. No. 5,433,651, U.S. Pat. No. 5,609,511, U.S. Pat. No. 5,643,046, U.S. Pat. No. 5,658,183, U.S. Pat. No. 5,730,642, U.S. Pat. No. 5,838,447, U.S. Pat. No. 5,872,633, U.S. Pat. No. 5,893,796, U.S. Pat. No. 5,949,927, and U.S. Pat. No. 5,964,643. Desirably, the inspection or monitoring of the progress of the polishing process with respect to a workpiece being polished enables the determination of the polishing end-point, i.e., the determination of when to terminate the polishing process with respect to a particular workpiece.

This example further illustrates the invention but, of course, should not be construed as in any way limiting its scope.

### EXAMPLE

In this example, the polishing experiments generally involved use of a commercially available polishing tool with 17.5 kPa (2.5 psi) downforce pressure of the substrate against the polishing pad, 22.5 kPa (3.3 psi) subcarrier pressure, 17.5 kPa (2.5 psi) back side pressure, 22.5 kPa (3.3 psi) ring pressure, 100 rpm platen speed, 55 rpm carrier speed, 150 mL/min polishing composition flow rate, and ex-situ conditioning of a concentric grooved CMP pad.

This example shows the effect of the average primary particle size of condensation-polymerized silica on the removal rate of silicon dioxide observed with the polishing composition of the invention.

Similar silicon dioxide layers were separately polished with three different polishing compositions (Compositions A-C). Each of the polishing compositions comprised 8 wt. % of a condensation-polymerized silica, 1000 ppm tetrabutylammonium hydroxide, 65 ppm malonic acid, 0.0506 wt. % ferric nitrate, 26 ppm of Kathon® biocide, and 2 wt. % hydrogen peroxide, at a pH of 3.3. The condensation-polymerized silicas used were the PL-2, PL-5, and PL-7 products of Fuso Chemical Co., Osaka, Japan. Composition A (invention) further comprised 8 wt. % silica having a 25 nm average primary particle diameter (Fuso PL-2). Composition B (comparative) further comprised 8 wt. % silica having a 50 nm average primary particle diameter (Fuso PL-5). Composition C (comparative) further comprised 8 wt. % silica having a 70 nm average primary particle diameter (Fuso PL-7).

Following use of the polishing compositions, the silicon dioxide (“oxide”) removal rates were determined. The results are set forth in the Table.

TABLE
Effect of silica primary particle size on silicon dioxide removal rate

| Polishing | Silica Average Primary | Oxide Rate |
|---|---|---|
| Composition | Particle Size (nm) | (Å/min) |
| A | 25 | 2525 |
| B | 50 | 1129 |
| C | 70 | 774 |

Any suitable amount of silica can be present in the polishing composition. Typically, about 0.1 wt. % or more silica can be present in the polishing composition (e.g., about 0.5 wt. % or more, or about 1 wt. % or more, or about 2 wt. % or more). The amount of silica in the polishing composition preferably will not exceed about 10 wt. %, and more preferably will not exceed about 8 wt. %. Even more preferably the silica will comprise about 0.5 wt. % to about 10 wt. % (e.g., about 1 wt. % to about 8 wt. %) of the polishing composition.

The polishing composition contains an oxidizing agent that acts on, i.e., oxidizes copper. The oxidizing agent is selected from the group consisting of hydrogen peroxide, urea hydrogen peroxide, percarbonate salts, benzoyl peroxide, peracetic acid, sodium peroxide, di-tert-butyl peroxide, monopersulfate salts, dipersulfate salts, nitrate salts, iron (III) compounds, and combinations thereof. The recited oxidizing agents, with the exception of iron (III) compounds, are referred to herein as per-type oxidizing agents. When the polishing composition contains nitrate salts, generally the polishing composition also will contain at least one other oxidizing agent selected from the specified group. Preferably, the oxidizing agent is selected from the group consisting of hydrogen peroxide, iron (III) compounds, and combinations thereof. More preferably, the oxidizing agent is a combination of hydrogen peroxide and an iron (III) compound, most preferably a combination of hydrogen peroxide and ferric nitrate.

The polishing composition can contain any suitable amount of the oxidizing agent. The polishing composition typically contains about 0.1 wt. % or more (e.g., about 0.5 wt. % or more, or about 1 wt. % or more, or about 1.5 wt. % or more) of the oxidizing agent. Preferably, the polishing composition contains about 10 wt. % or less (e.g., about 9 wt. % or less, or about 8 wt. % or less, or about 7 wt. % or less) of the oxidizing agent.

When the polishing composition contains a combination of a per-type oxidizing agent and an iron (III) compound, typically the polishing composition will contain about 1 ppm or more (e.g., about 5 ppm or more, or about 10 ppm or more, or about 20 ppm or more) of the iron (III) compound. Preferably, about 100 ppm or less (e.g., about 90 ppm or less, or about 80 ppm or less) of the iron (III) compound is present in the polishing composition. In such a situation, the polishing composition desirably contains an amount of the per-type oxidizing agent as generally recited for the oxidizing agent. Without wishing to be bound by any particular theory, when the polishing composition is used to polish a substrate comprising a metal, it is believed that the iron (III) compound serves to oxidize the metal by accepting an electron from the metal, thereby becoming reduced to an iron (II) compound. The per-type

The results shown in the Table demonstrate that the use of condensation-polymerized silica having an average primary particle size of 25 nm provides significantly enhanced removal rates in the polishing of silicon dioxide layers as compared with condensation-polymerized silica having an average primary particle size of 50 nm or 70 nm.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition consisting essentially of:
(a) silica having an average primary particle size of about 10 nm to about 40 nm,
(b) an oxidizing agent selected from the group consisting of hydrogen peroxide, urea hydrogen peroxide, percarbonate salts, benzoyl peroxide, peracetic acid, sodium peroxide, di-tert-butyl peroxide, monopersulfate salts, dipersulfate salts, nitrate salts, iron (III) compounds, and combinations thereof,
(c) a quaternary ammonium compound comprising a cation with the structure R₁R₂R₃R₄N⁺ wherein R₁, R₂, R₃, and R₄ are independently selected from the group consisting of C₂-C₆ alkyls and C₇-C₁₂ arylalkyls, and
(d) water,
wherein the polishing composition has a pH of about 1 to about 5.

2. The polishing composition of claim 1, wherein the silica is condensation-polymerized silica.

3. The polishing composition of claim 2, wherein the silica is present in an amount of about 0.1 wt. % to about 10 wt. %.

4. The polishing composition of claim 3, wherein the silica is present in an amount of about 0.5 wt. % to about 8 wt. %.

5. The polishing composition of claim 1, wherein the oxidizing agent is a combination of hydrogen peroxide and an iron (III) compound.

6. The polishing composition of claim 5, wherein the iron (III) compound is ferric nitrate.

7. The polishing composition of claim 6, wherein the hydrogen peroxide is present in an amount of about 1 wt. % to about 10 wt. %, and the ferric nitrate is present in an amount of about 0.1 ppm to about 100 ppm.

8. The polishing composition of claim 1, wherein the quaternary ammonium compound is present in an amount of about 100 ppm to about 5000 ppm.

9. The polishing composition of claim 8, wherein the quaternary ammonium compound comprises a cation selected from the group consisting of tetraethylammonium, tetrapropylammonium, tetrabutylammonium, and tetrapentylammonium.

10. A method of chemically-mechanically polishing a substrate, which method comprises:
(i) contacting a substrate with a polishing pad and a chemical-mechanical polishing composition consisting essentially of:
(a) silica having an average primary particle size of about 10 nm to about 40 nm,
(b) an oxidizing agent selected from the group consisting of hydrogen peroxide, urea hydrogen peroxide, percarbonate salts, benzoyl peroxide, peracetic acid, sodium peroxide, di-tert-butyl peroxide, monopersulfate salts, dipersulfate salts, nitrate salts, iron (III) compounds, and combinations thereof,
(c) a quaternary ammonium compound comprising a cation with the structure R₁R₂R₃R₄N⁺ wherein R₁, R₂, R₃, and R₄ are independently selected from the group consisting of C₂-C₆ alkyls and C₇-C₁₂ arylalkyls, and
(d) water,
wherein the polishing composition has a pH of about 1 to about 5,
(ii) moving the polishing pad relative to the substrate with the chemical-mechanical polishing composition therebetween, and
(iii) abrading at least a portion of the substrate to polish the substrate.

11. The method of claim 10, wherein the silica is condensation-polymerized silica.

12. The method of claim 11, wherein the silica is present in an amount of about 0.1 wt. % to about 10 wt. %.

13. The method of claim 12, wherein the silica is present in an amount of about 0.5 wt. % to about 8 wt. %.

14. The method of claim 10, wherein the oxidizing agent is a combination of hydrogen peroxide and an iron (III) compound.

15. The method of claim 14, wherein the iron (III) compound is ferric nitrate.

16. The method of claim 15, wherein the hydrogen peroxide is present in an amount of about 0.1 wt. % to about 10 wt. %, and the ferric nitrate is present in an amount of about 1 ppm to about 100 ppm.

17. The method of claim 10, wherein the quaternary ammonium compound is present in an amount of about 100 ppm to about 5000 ppm.

18. The method of claim 18, wherein the quaternary ammonium compound comprises a cation selected from the group consisting of tetraethylammonium, tetrapropylammonium, tetrabutylammonium, and tetrapentylammonium.

19. The method of claim 10, wherein the substrate comprises silicon oxide.

20. The method of claim 19, wherein the substrate further comprises a metal selected from the group consisting of tungsten, copper, tantalum, tantalum nitride, aluminum, titanium, titanium nitride, and combinations thereof.
